(19) United States
(12) Patent Application Publication
(10) Pub. No.: US 2005/0038596 A1
(43) Pub. Date: Feb. 17, 2005

(54) Navigation system using wireless paging network and method of providing traffic information therefor

(75) Inventors: Sung-Chul Yang, Suwon-si (KR); Yong-Ik Choi, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/858,256

(22) Filed: Jun. 1, 2004

(30) Foreign Application Priority Data
Aug. 14, 2003 (KR) P2003-56589

(51) Int. Cl. G01C 21/26

(52) U.S. Cl. 701/200; 340/995.13

(57) ABSTRACT

A navigation system using a wireless paging network and a traffic information providing method in the navigation system. The navigation system has a traffic information management server, a paging server and a navigation terminal. The paging server broadcasts real-time information including traffic information and living information (e.g., breaking news) and the navigation terminal provides traffic information with the real-time information to a user. Therefore, no extra communication charges are imposed and real-time traffic information and other living information (e.g., breaking news, incident information, etc.) are provided together with route guidance information.

### PRIORITY

This application claims priority under 35 U.S.C. § 119 to an application entitled “Navigation System Using Wireless Paging Network and Method of Providing Traffic Information Therefor” filed in the Korean Intellectual Property Office on Aug. 14, 2003 and assigned Serial No. 2003-56589, the contents of which are incorporated herein by reference.

### BACKGROUND OF THE INVENTION

1. Field of the Invention

The present invention relates generally to a navigation communication system, and in particular, to a navigation system for broadcasting real-time information including traffic information and living information (e.g., breaking news) via a high-speed wireless paging network and enabling a terminal (e.g., a navigation terminal or a traffic information terminal) mounted in a vehicle to provide the real-time information to a user, and a method of providing the traffic information in the navigation system.

2. Description of the Related Art

Commonly, mobile objects such as boats, aircrafts, and motor vehicles are equipped with GPS (Global Positioning System) devices. A GPS device (or a navigation device) calculates the current position of a mobile object by receiving signals representing latitude, longitude, and altitude from a plurality of GPS satellites and displays a map including the position based on previously stored map data. That is, the typical navigation device provides information necessary for driving to a driver using GPS information by, for example, displaying the current velocity of the vehicle, a route set by the driver before driving, and an optimum route to a destination.

A positioning technique and a routing technique are essential to the navigation device. The present invention is related to the latter. In general, routing is performed based on a digital map database (DB), the present position, and destination information. Commonly, for the routing, a digital Dijkstra algorithm or an A* algorithm is used.

Traffic information should be reflected in the algorithm to achieve a higher level of satisfaction with the routing result of the navigation device. In addition, traffic information should be updated continuously during the travel, considering the continuous change of the traffic information.

Traditionally, a driver is connected to a traffic information management server via a mobile communication network for routing with traffic information. For example, the driver calls the traffic information management server or makes a data communication connection before leaving for the destination. During traveling, the user is reconnected to the traffic information management server for route guidance, when necessary.

FIG. 1 is a block diagram of a conventional navigation system for providing traffic information via a mobile communication network. Referring to FIG. 1, a navigation terminal 10 is connected to a traffic server 20 to receive real-time traffic information while traveling. The traffic server 20 then provides traffic information about a requested area using a traffic information DB 25. To provide real-time traffic information, a call should be connected between the navigation terminal 10 and the traffic server 20. As a result, when a route is guided according to route guidance data reflecting traffic information from a departure to a destination, it is possible that a vehicle is brought into a congested traffic area because the area was at a good traffic condition initially, but the traffic condition changes during travel. To avoid this problem, the driver calls the traffic server 20 or conducts a data communication to utilize the traffic information DB 25 each time the user wants to receive updated route guidance data reflecting real-time traffic information. As a result, the user is charged an additional communication rate in addition to a DB use fee.

Another traffic information-reflected routing method is to provide traffic information over a mobile communication system by a broadcast message. However, this conventional method also has a shortcoming that a user is supposed to pay a high expense for using the mobile communication network.

As a third traffic information-reflected routing method, a traffic information transmission scheme using an additional FM broadcasting service has been developed. According to this scheme, traffic information about specific areas or a wide area to avoid is transmitted. Therefore, real-time optimum routing based on traffic information updated in a short period is not available. Moreover, the use of the additional FM broadcasting service requires installation for an additional device for additional FM carriers. That is, there is a need for hardware equipment in addition to a general-purpose mobile communication means such as a portable terminal or communication module used for navigation. Additionally, a route cannot be computed in real time using traffic information transmitted by the additional FM broadcasting. Also, because the traffic information is provided simply by a text message, this system may have a detrimental effect on safe driving because the user must read a message while driving. Further, because of low reception sensibility, the traffic information cannot be received accurately and a service provider has difficulty charging subscribers fees for receiving the service.

### SUMMARY OF THE INVENTION

It is, therefore, an object of the present invention to provide a navigation system for searching for an optimum route using real-time traffic information.

It is another object of the present invention to provide a navigation system for transmitting real-time traffic information via a high-speed wireless paging network and searching for an optimum route in real time using the real-time traffic information, and a method for providing the traffic information in the navigation system.

It is a further object of the present invention to provide a navigation system for transmitting real-time living information, such as breaking news, via a high-speed wireless paging network and providing traffic information with the living information, and a traffic information providing method in the navigation system.

The above objects are achieved by a navigation system using a wireless paging network and a traffic information providing method in the navigation system.

According to one aspect of the present invention, in the navigation system, a traffic information management server stores and manages real-time information including traffic information and living information from an external information server. A paging server transmits the real-time information stored in the traffic information management server via a wireless paging network. A navigation terminal receives the real-time information from the paging server and provides traffic information together with the real-time information to a user.

According to another aspect of the present invention, in the method of providing traffic information in a navigation system, real-time information including traffic information and living information is received/managed from a wireless paging network. The real-time information is decoded and the type of the real-time information is determined by analyzing the real-time information. The real-time information is stored separately according to the type of the real-time information. An optimum route is calculated based on the real-time information upon request for a route guidance service. Route guidance is provided using the calculated route information together with the real-time information.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a conventional navigation system for providing traffic information;

FIG. 2 is a block diagram of a navigation system according to an embodiment of the present invention;

FIG. 3 is a block diagram of a navigation terminal according to the embodiment of the present invention;

FIGS. 4A, 4B, and 4C illustrate the formats of messages delivered to provide traffic information according to the embodiment of the present invention;

FIGS. 5A and 5B illustrate tables listing transmission messages and their features according to the embodiment of the present invention; and

FIGS. 6A, 6B, and 6C are flowcharts illustrating an operation for providing traffic information according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail because they would obscure the invention in unnecessary detail.

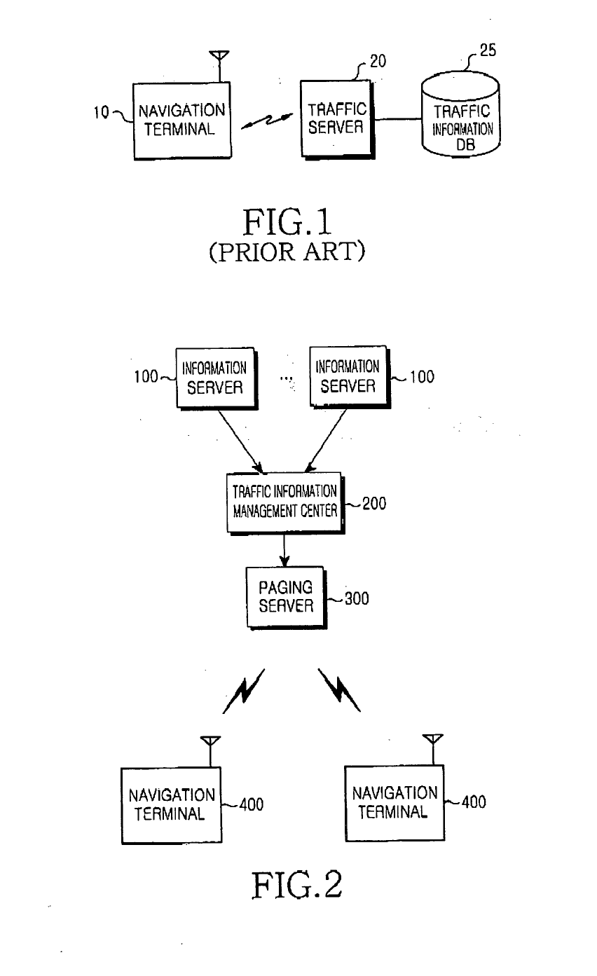

FIG. 2 is a block diagram of a navigation system according to an embodiment of the present invention. The navigation system includes information servers 100, a traffic information management center 200, a paging server 300, and navigation terminals 400. The information servers 100 collect a variety of real-time information useful to drivers, such as the traffic conditions of individual roads, weather forecast, and breaking news, and provide it to the traffic information management center 200 in real time. How the information servers 100 collect the real-time information is beyond the scope of the present invention and thus its description is not provided here.

The traffic information management center 200 stores/manages the real-time information received from the information servers 100 and additional information needed to manage the navigation terminals 400. The additional information includes control messages for controlling communication modems in the navigation terminals 400 and messages related to registering the location of radio pagers used as the communication modems in the embodiment of the present invention.

The traffic information management center 200 classifies the real-time information into numerical information and text information, and stores/manages the information for a predetermined period. The reason for storing the information for the limited time is that the information (e.g., traffic information, breaking news, etc.) is meaningful as far as it is provided to users in real time and becomes obsolete when some time elapses. The navigation terminals 400 utilize the numerical information and the text information in different manners. That is why the real-time information is classified into the numerical information and the text information.

The numerical information represents real-time velocities at specific points corresponding to nodes and links on a digital map. The numerical information is referred to when the navigation terminals 400 compute routes. The text information is displayed on the navigation terminals 400 in the form of text. Generally, the numerical data is constructed in a binary form, whereas the text data is formed in an ASCII form. Therefore, the traffic information management center 200 stores the real-time information separately as the numerical information and the text information according to data type.

The paging server 300 is a server responsible for controlling/managing a wireless paging network. The paging server 300 wirelessly transmits the information stored in the traffic information management center 200 to the navigation terminals 400 periodically or in real time. In general, the paging server 300 periodically broadcasts traffic information for use in route computation, and transmits information about incidents in a specific area, breaking news, and typical wireless paging messages in real time.

There is a slow wireless paging network adopting POCSAG (Post Office Code Standardization Advisory Group) and a fast wireless paging network adopting FLEX (Flexible). The latter is preferably used in the present invention because it enables a data rate of up to 6400 bps and has the benefits of reinforced error correction, increased battery life, easy system expansion, efficient data transmission, and increased subscriber capacity per channel. Therefore, the fast wireless paging system is suitable for transmission of a large volume of text data. That is, in view of the advantages, the fast wireless paging scheme is feasible for transmission of traffic information, comprehensive information, and individual information.

The paging server 300 transmits the real-time information to a plurality of users by a broadcast message (BM) or a particular user by an individual message (IM) depending on the characteristics of the information. While the traffic information is delivered by the BM, a message destined for the particular user or a message for modem control is delivered as an IM.

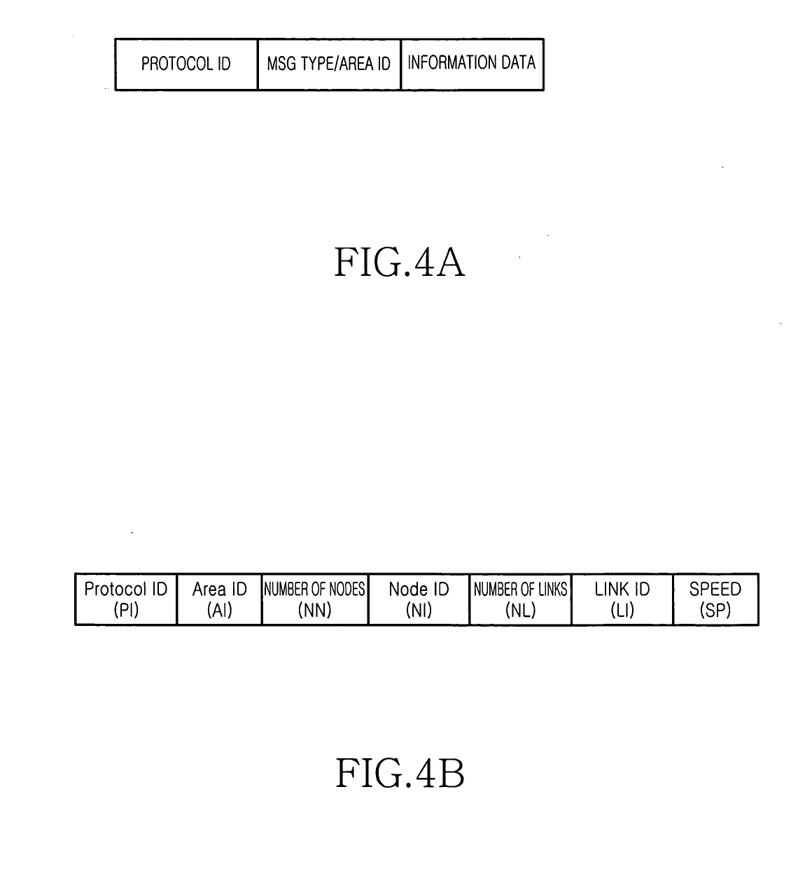

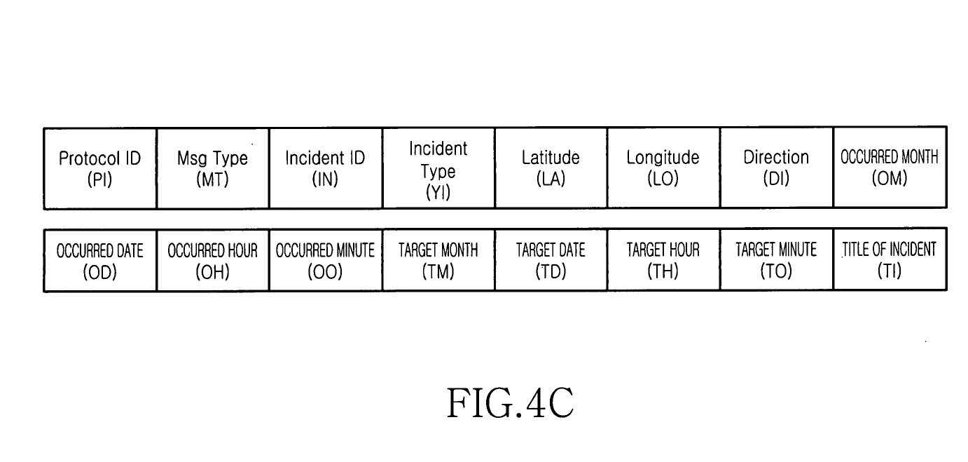

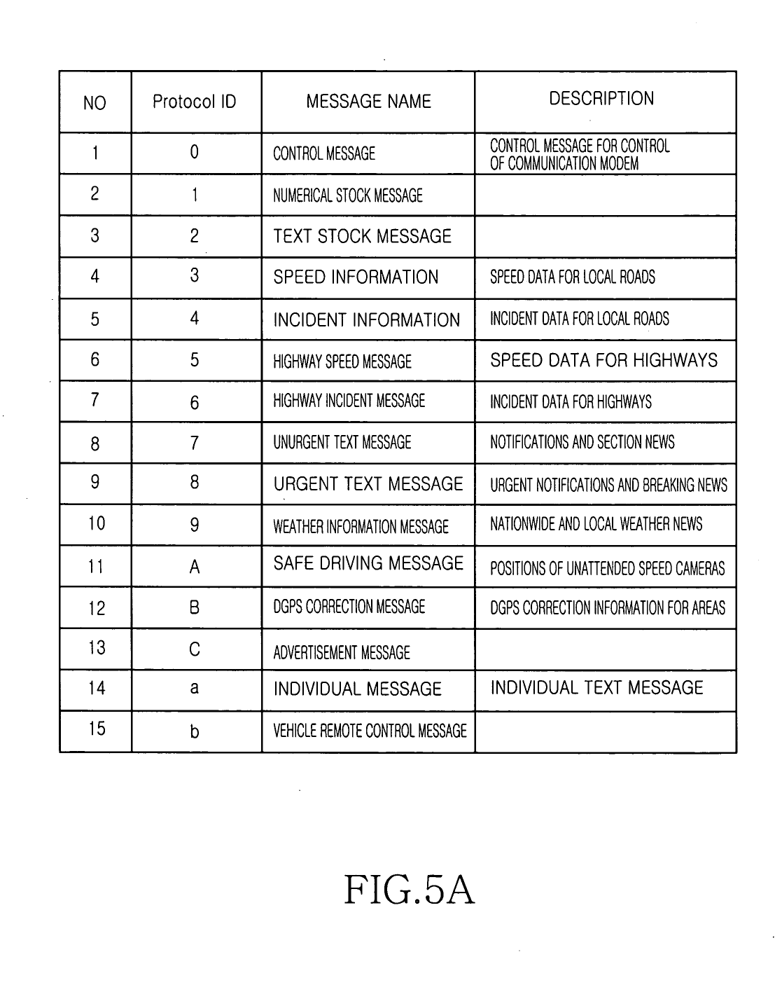

FIGS. 4A, 4B, and 4C illustrate exemplary messages transmitted from the paging server 300 to the navigation terminals 400. FIGS. 4A, 4B, and 4C will be described in more detail herein below.

The navigation terminals 400 store information received from the paging server 300 separately according to information types and provides traffic information with the real-time information to users.

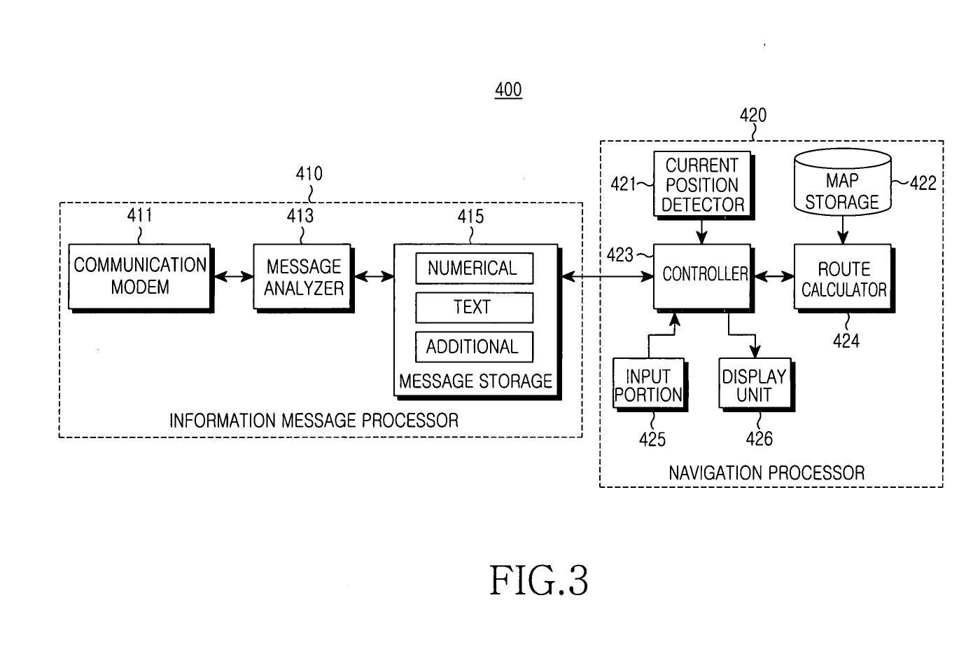

FIG. 3 is a block diagram of each of the navigation terminals 400 according to the embodiment of the present invention. Referring to FIG. 3, the navigation terminal 400 comprises an information message processor 410 and a navigation processor 420. The information message processor 410 processes real-time information and additional information received via the wireless paging network. The navigation processor 420 performs typical navigation functions such as calculating the current position of a mobile object and displaying it, or guiding a user to a route as requested. These processors can be built separately. For example, an existing navigation device mounted in a vehicle can be used as the navigation processor 420. The navigation processor 420 can be a PDA-type portable navigation device and the information message processor 410 can be built in a cradle for the portable terminal in the vehicle.

More specifically, the information message processor 410 is comprised of a communication modem 411, a message analyzer 413, and a message storage 415. The communication modem 411 receives the real-time information and addition information from the wireless paging network. Preferably, it is a radio pager. Alternatively, the communication modem 411 can be configured as a separate device relying on a power supply within the vehicle, connected interactively to the navigation terminal 400 via an interface like a UART (Universal Asynchronous Receiver Transmitter) or USB (Universal Serial Bus).

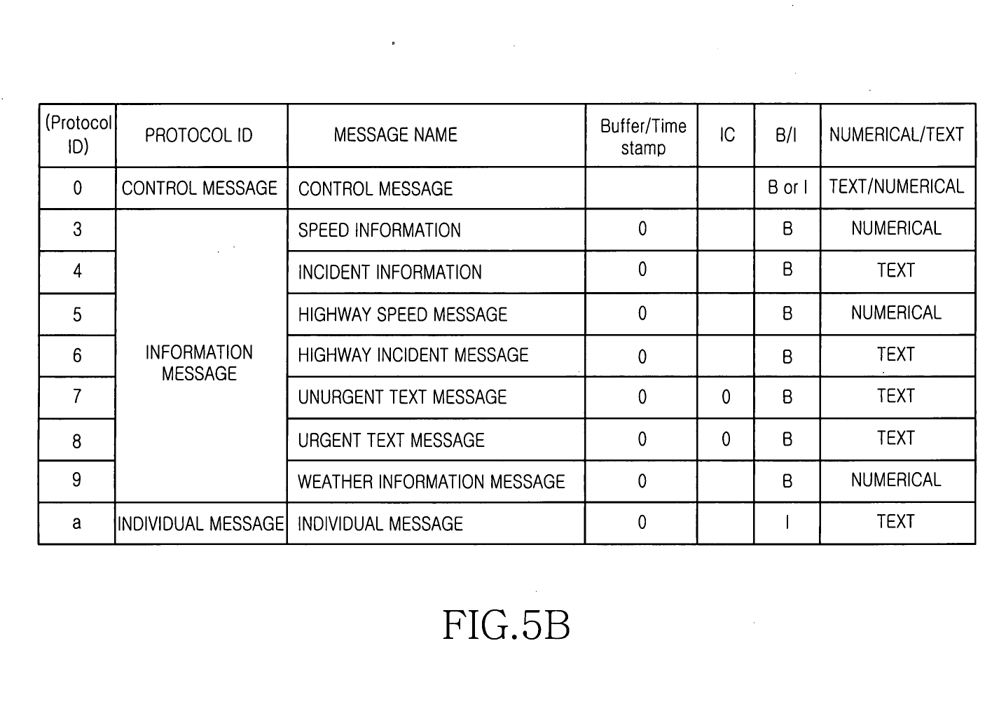

The message analyzer 413 decodes the real-time information and addition information from the communication modem 411 and classifies the decoded information according to data types. When analyzing the received information, the message analyzer 413 identifies a message type using a protocol ID (Identification) set in the header of a message packet. The protocol ID will be described later in more detail with reference to FIGS. 5A, 5B, and 5C.

The message storage 415 separately stores the classified data. Additional information and real-time information are received through the communication modem 411. The real-time information is further branched into numerical information and text information. As a result, the message storage 415 stores the received information separately as the numerical information, the text information, and the additional information.

The navigation processor 420 includes a current position detector 421, a map storage 422, a controller 423, a route calculator 424, an input portion 425, and a display unit 426. The current position detector 421 detects the current position of the mobile object having the navigation terminal 400 mounted therein. To do so, the current position detector 421 is provided with a GPS receiver and detects the current position using GPS signals received through the GPS receiver.

The map storage 422 stores a digital map necessary for position detection and route computation. The map storage 422 is optional depending on the operational characteristics of the navigation terminal 400. When the navigation terminal 400 acquires map information by accessing a separate server that manages the digital map, the map storage 422 is not needed. Because the digital map contains the same nodes and links as in the numerical map data collected/managed by the traffic information management center 200, a route can be calculated with numerical information stored in the message storage 415, considering traffic information.

The controller 423 controls the operation of the navigation processor 420 according to a control command received through the input portion 425 and displays the operation result on the display unit 426. For example, if a user requests an optimum route from his current position to a destination, the controller 423 feeds information about the current position received from the current position detector 421 and information about the destination to the route calculator 424 and controls the route calculator 424 to calculate the optimum route. The controller 423 receives information about a calculated route from the route calculator 424 and displays the route on the display unit 426. Here, the controller 423 reads numerical or text information from the message storage 415 and transmits the numerical information to the route calculator 424 for route computation or the text information to the display unit 426. Additionally, the controller 423 checks messages stored in the message storage 415 periodically even during route guidance and displays them on the display unit 426 according to the types of the messages.

The input portion 425 includes a keypad and/or microphone, for receiving a control command generated by key manipulation and/or a voice command, respectively. The display unit 426 has a display and/or a speaker, for respectively providing the operation result of the controller 423 visually and audibly.

As indicated above, FIGS. 4A, 4B, and 4C illustrate the formats of transmission messages required for providing traffic information according to the embodiment of the present invention. FIG. 4A illustrates a common structure to the messages, FIG. 4B illustrates the structure of a numerical information message (e.g. speed information message), and FIG. 4C illustrates the structure of a text information message (e.g. incident notification message).

Referring to FIG. 4A, a message transmitted from the paging server 300 illustrated in FIG. 2 to the navigation terminals 400 illustrated in FIG. 2 contains Protocol ID, Msg Type/Area ID, and information data. Msg Type/Area ID. The structure of an information data area are defined according to Protocol ID. Protocol IDs are listed in FIG. 5A.

Referring to FIG. 4B, a numerical information message (e.g., a speed information message) transmitted from the paging server 300 to the navigation terminals 400 contains Protocol ID (PI), Area ID (AI), Number of Node (NN), Node ID (NI), Number of Link (ML), Link ID (LI), and Speed (SP). PI indicates that this message provides road speed information. It further indicates the type of a road (e.g. local road, highway, etc.). AI identifies an area since a wireless paging network is usually provided on a service area basis. NN indicates the number of node data items included in the message and NI provides the IDs of the nodes. NL indicates the number of link data items included in the message and LI provides the IDs of the links. SP indicates an average velocity on the road.

Referring to FIG. 4C, a text information message (e.g., an incident notification message) transmitted from the paging server 300 to the navigation terminals 400 contains PI, Msg Type (MT), Incident ID (IN), Latitude (LA), Longitude (LO), Direction (DI), Occurred Month (OM), Occurred Date (OD), Occurred Hour (OH), Occurred minute (OO), Target Month (TM), Target Hour (TH), Target minute (TO), and Title of Incident (TI).

The incident notification message indicates the time an incident occurred and an expected incident clear time. That is, the incident notification message contains PI, an ID (MT) for indicating that this message provides incident information, the type of an incident occurred (IN), a place where the incident occurred (LA, LO, and DI), time the incident occurred (OM, OD, OH, and OO), and expected incident clear time (TM, TD, TH, and TO). The navigation terminals 400 illustrated in FIG. 2, which receive the incident notification message, determine how long the incident notification is valid.

Besides the incident notification message illustrated in FIG. 4C, text information messages further include non-urgent text information (e.g., notifications, section news, etc.), urgent text information, nationwide weather forecast, or weather news for specific areas, information about unattended speed cameras, and DGPS (Differential Global Positioning System) correction information for areas.

FIGS. 5A and 5B illustrate message types and their features according to the embodiment of the present invention. More specifically, FIG. 5A is a table listing transmission message types. Referring to FIG. 5A, 15 messages transmitted from the paging server 300 to the navigation terminals 400 are defined.

FIG. 5B is a table listing transmission messages classified by PI and their features. Referring to FIG. 5B, information messages and individual messages, not including control messages, are stored in the message storage 415, for use in the navigation processor 420. Time stamps for indicating received time are attached to the information and individual messages. The communication modem 411 of a navigation terminal 400 receiving such a message determines whether the message is valid according to the received time information. The communication modem 411 can determine from the PI the way the message is delivered, that is, whether the message is a broadcast message (B) or an individual message (I), and whether the message is numerical or text, as noted from FIG. 5B.

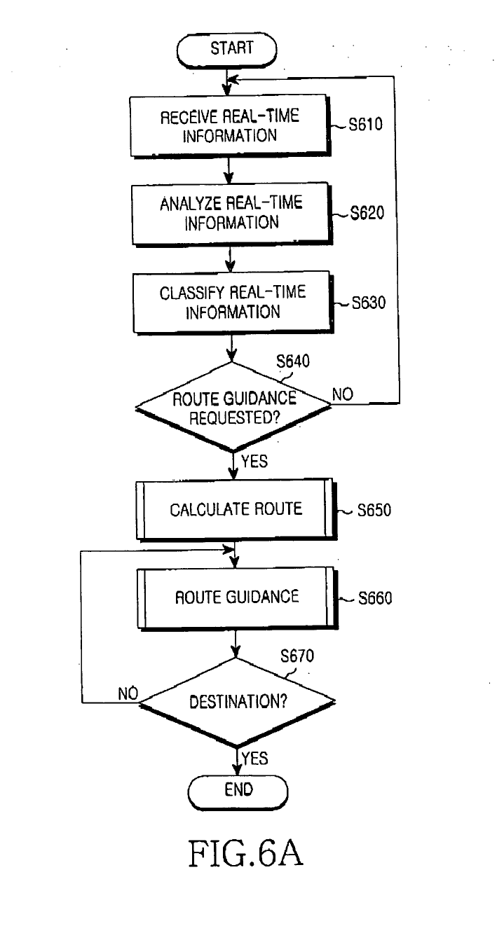

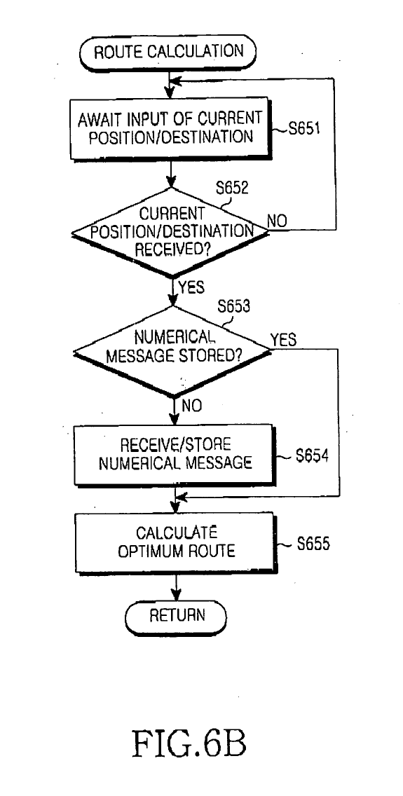

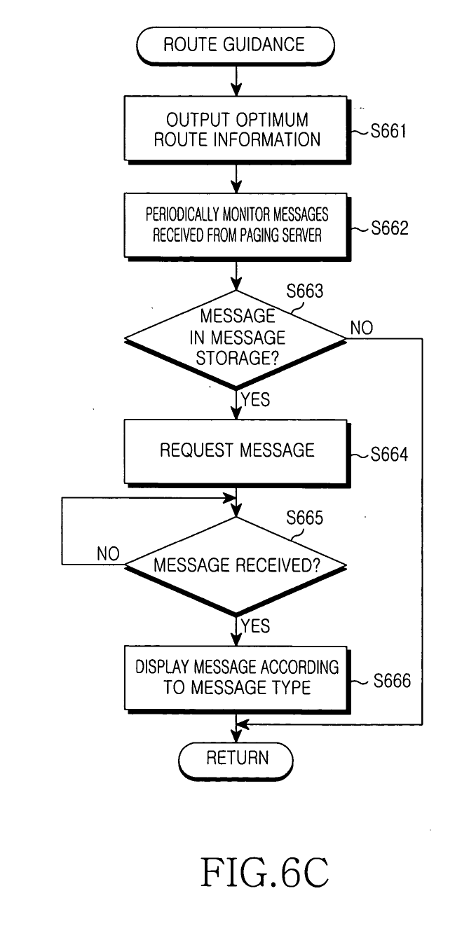

FIGS. 6A, 6B, and 6C are flowcharts illustrating an operation for providing traffic information according to the embodiment of the present invention. FIG. 6A illustrates an operation for processing traffic information according to the embodiment of the present invention. Referring to FIGS. 3 and 6A, the information message processor 410 of the navigation terminal 400 stores real-time information received from the wireless paging network. That is, the communication modem 411 periodically monitors real-time information (e.g., traffic information and breaking news) destined for the navigation terminal 400 and receives a message in step S610. The message analyzer 413 analyzes the message, which is formatted as illustrated in FIGS. 4A, 4B, and 4C, in step S620 and stores the message in the message storage 415 according to the type of its real-time information identified by its PI in step S630.

Further, the communication modem 411 may receive additional information for controlling the operation and operational environment of the navigation terminal 400. As described above, real-time information is divided into numerical information and text information. Therefore, the real-time information is stored separately as numerical information and text information in step S630. If the additional information is also received in step S610, the additional information is stored separately from the real-time information.

Upon receipt of a route guidance service request from a user, the navigation processor 420 guides the user to a route according to the real-time information stored in the message storage 415. That is, upon request for the route guidance service from the user in step S640, the controller 423 receives the request message through the input portion 425, reads the numerical information including real-time traffic information from the message storage 415, and calculates an optimum route based on the real-time traffic information in step S650. In step S660, the controller 423 notifies the user of the optimum route. It is preferable to guide the user to the optimum route visually and/or audibly.

However, in the absence of the route guidance service request from the user in step S640, the communication modem 411 periodically monitors messages destined for the navigation terminal 400, receives a corresponding message, analyzes it, and stores it.

Step S660 lasts until the user arrives at his destination in step S670. That is, when the user reaches the destination during the route guidance in step S670, the procedure is terminated.

FIG. 6B illustrates the route computation step S650 in more detail. Referring to FIGS. 3 and 6B, to perform step S650, the controller 423 awaits reception of information about a current position and a destination from the user in step S651. Upon receipt of the current position and destination information from the user in step S652, the controller 423 determines whether numerical information has been stored in the message storage 415 in step S653. If numerical information has been stored in the message storage 415, the controller 423 transmits the numerical information to the route calculator 424 (not shown). In step S655, the route calculator 424 calculates the optimum route based on the numerical information.

However, if numerical information has not been stored in the message storage 415, the controller 423 controls the communication modem 411 to receive the latest message transmitted from the traffic information management center 200 and then, the communication modem 411 stores the received numerical information in the message storage 415 in step S654 and a route calculator 424 calculates an optimum route using the stored numerical information (not shown). Because the navigation terminal of the present invention is usually carried in a vehicle, once the vehicle starts, the communication modem 411 automatically functions as a typical radio pager. The communication modem 411 determines whether there are messages received from the paging server 300 before the vehicle is not started. If there are messages received from the paging server 300 before the vehicle is not started, the communication modem 411 analyzes the message and stores them in the message storage 415. Therefore, the message storage 415 always has the latest information.

FIG. 6C illustrates the route guidance step S660 in more detail. Referring to FIGS. 3 and 6C, the controller 423 outputs optimum route information received in step S650 of FIG. 6B in step S661. Here, the optimum route information can be provided visibly, audibly, or both. The controller 423 periodically checks the information stored in the message storage 415 in step S662 and determines whether there is a new message in step S663. In the presence of the new message, the controller 423 requests it from the message storage 415 in step S664. Upon receipt of the new message in step S665, the controller 423 displays it on the display unit 426 in step S666. Before displaying the message, the controller 423 determines the type of the message. If the message is numerical data for use in route computation, the controller 423 does not display it on the display unit 426. The controller 423 displays only text data on the display unit 426.

It is preferable to restrict the message presence/absence decision of step S663 to text messages in the message storage 415, in order to avoid determining the message type in step S666. For example, the controller 423 determines whether a new text message is in the message storage 415 in step S663 and requests it from the message storage 415 in step S664. In the case of an urgent message, such as an incident notification message or breaking news, or a radio paging message for the user, a current window on the display unit 426 is changed even during route guidance, or a new window is invoked over a route guiding window to alert the user. However, when there is no-breaking news or weather news, it is displayed slidingly in a predetermined portion, for example, in an upper or lower portion of the display unit 426.

In accordance with the present invention as described above, the navigation system using the wireless paging network and the traffic information providing method in the navigation system impose no extra communication charges and provide real-time traffic information and other living information (e.g., breaking news, incident information, etc.) together with route guidance information. Particularly, real-time speed information is reflected in computation of an optimum route. Therefore, the optimum route is set in the manner that avoids heavy traffic areas.

While the present invention has been shown and described with reference to a certain preferred embodiment thereof, it will be understood by those skilled in the art that various changes in form and details may be made therein without departing from the spirit and scope of the present invention as defined by the appended claims.

1. A navigation system comprising:
a traffic information management server for storing and managing real-time information including traffic information and living information from an external information server;
a paging server for transmitting the real-time information stored in the traffic information management server via a wireless paging network; and
a navigation terminal for receiving the real-time information from the paging server and providing the traffic information together with the real-time information to a user.

2. The navigation system of claim 1, wherein the traffic information management server stores the real-time information separately as real-time numerical information and real-time text information, the real-time numerical information representing a speed at a point corresponding to each node and link on a digital map and being used for a route computation, and the real-time text information being displayed in text through the navigation terminal.

3. The navigation system of claim 1, wherein the traffic information management server stores and manages the real-time information for a predetermined valid period.

4. The navigation system of claim 1, wherein the wireless paging network uses a high-speed wireless paging scheme.

5. The navigation system of claim 1, wherein the paging server transmits the real-time information to one of a plurality of users by a broadcast message and a predetermined user by an individual message.

6. The navigation system of claim 1, wherein the navigation terminal comprises:
an information message processor for receiving from the paging server the real-time information and additional information for controlling and storing the real-time information and the additional information; and
a navigation processor for calculating an optimum route based on the real-time information a upon request from the user and guiding the user to the optimum route.

7. The navigation system of claim 6, wherein the information message processor comprises:
a communication modem for receiving the real-time information and the additional information from the paging server;
a message analyzer for decoding the real-time and the additional information received from the communication modem and classifying the decoded information into the real-time numerical information, the real-time text information, and the additional information; and
a message storage for separately storing the real-time numerical information, the real-time text information, and the additional information.

8. The navigation system of claim 7, wherein the communication modem is a radio pager.

9. The navigation system of claim 6, wherein the information message processor is configured as a separate device, which uses a power supply within a vehicle and interacts with the navigation processor via one of a UART (Universal Asynchronous Receiver Transmitter) and a USB (Universal Serial Bus) interface.

10. A navigation terminal comprising:
an information message processor for receiving real-time information and additional information for controlling from a wireless paging network and storing the real-time information and the additional information; and
a navigation processor for calculating an optimum route based on the real-time information, upon a request from a user, and guiding the user via the optimum route.

11. The navigation terminal of claim 10, wherein the information message processor comprises:
a communication modem for receiving the real-time information and the additional information from the wireless paging network;
a message analyzer for decoding the real-time and the additional information received from the communication modem and classifying the decoded information into real-time numerical information, real-time text information, and the additional information; and
a message storage for separately storing the real-time numerical information, the real-time text information, and the additional information.

12. The navigation terminal of claim 11, wherein the communication modem is a radio pager.

13. The navigation terminal of claim 10, wherein the information message processor is configured as a separate device, which uses a power supply within a vehicle and interacts with the navigation processor via one of a UART (Universal Asynchronous Receiver Transmitter) and a USB (Universal Serial Bus) interface.

14. A method of providing traffic information in a navigation system, comprising the steps of:
(1) storing and managing real-time information, including traffic information and living information, from an wireless paging network;
(2) decoding the real-time information and determining a type of the real-time information by analyzing the real-time information;
(3) storing the real-time information separately according to the type of the real-time information;
(4) calculating an optimum route based on the real-time information, upon a request for a route guidance service; and
(5) providing the route guidance service using the calculated route information together with the real-time information.

15. The method of claim 14, wherein the real-time information received in the step (1) is the real-time numerical information containing fields including at least one of a Protocol Identification (ID), an Area ID, a Number of Node, a Node ID, a Number of Link, a Link ID, and a Speed.

16. The method of claim 14, wherein the real-time information received in the step (1) is the real-time text information containing fields including at least one of a Protocol Identification (ID), a Message Type, an Incident ID, a Latitude, a Longitude, a Direction, an Occurred Month, an Occurred Date, an Occurred Hour, an Occurred Minute, a Target Month, a Target Hour, a Target Minute, and a Title of Incident.

17. The method of claim 14, wherein it is determined in the step (2) whether the real-time information is the real-time numerical information representing a speed at a point corresponding to each node and link on a digital map and being used for the route computation service, or the real-time text information being displayed in text.

18. The method of claim 17, wherein the optimum route is calculated based on the real-time numerical information in the step (4).

19. The method of claim 17, wherein in an absence of the stored real-time numerical information, a numerical message is received and stored in the step (4).

20. The method of claim 18, wherein in an absence of the stored real-time numerical information, a numerical message is received and stored in the step (4).

21. The method of claim 14, wherein the step (5) comprises the steps of:
periodically determining whether the real-time information has been received from the wireless paging network, while the calculated optimum path is notified in the step (4);
determining the type of the real-time information, upon receipt of the real-time information; and
displaying the real-time information on a route guidance window, if the real-time information is the real-time text information.

22. The method of claim 14, wherein the step (5) comprises the steps of:
periodically determining whether the real-time text information has been received from the wireless paging network, while the calculated optimum path is notified in the step (4); and
displaying the real-time text information on a route guidance window when the real-time text information has been received.
